(19) United States
(12) Patent Application Publication
(10) Pub. No.: US 2009/0130277 A1
(43) Pub. Date: May 21, 2009

(54) Coffee roasting machine and system and method of use

(76) Inventors: Gorm Bressner, Providence, RI (US); Richard N. Caron, Needham, MA (US); John DeCarlo, Worcester, MA (US); Paul Boisvert, Worcester, MA (US); Randy Peckham, Worcester, MA (US); Enzo Finelli, Needham, MA (US); Kenneth P. Wlosek, Mahwah, NJ (US)

Correspondence Address: ARENT FOX LLP, 1050 CONNECTICUT AVENUE, N.W., SUITE 400, WASHINGTON, DC, 20036, US

(21) Appl. No.: 11/417,260

(22) Filed: May 4, 2006

Related U.S. Application Data
(63) Continuation of application No. 11/229,558, filed on Sep. 20, 2005, now abandoned.
(60) Provisional application No. 60/610,963, filed on Sep. 20, 2004.

(51) Int. Cl. A23N 12/08; A23N 12/10

(52) U.S. Cl. 426/466; 99/483; 99/468

(57) ABSTRACT

A coffee roasting machine for roasting coffee, particularly in small batch sizes for sale and distribution to individual customers. The coffee roaster is suitable for placement entirely within a retail sales outlet or establishment and for being operated by any person, such as, an employee, customer, or patron who has little or no knowledge, skill, or experience in roasting coffee beans. The coffee-roasting machine selects an appropriate coffee roasting instruction set, stored internally, that corresponding to information input into the coffee-roasting machine for roasting a particular type of coffee bean or coffee bean blend to a desired roast level. The information is integrally included on a package of coffee beans for roasting and is directly readable by the machine or manually inputtable by an operator.

### CROSS REFERENCE TO RELATED APPLICATIONS

This application claims the benefit of U.S. patent application Ser. No. 11/229,558, filed on Sep. 20, 2005, which claims priority to U.S. Provisional Application No. 60/610,963, filed Sep. 20, 2004, both of which are incorporated herein by reference in its entirety.

### BACKGROUND OF THE INVENTION

1. Field of the Invention

The present invention relates to a coffee roasting machine, and particularly to a machine for roasting coffee in small batch sizes for sale and distribution to individual customers. Additionally, the coffee roaster of the present invention is suitable for placement within retail sales outlets or establishments and operated by any person, such as, an employee, customer, or patron who has little or no knowledge, skill, or experience in roasting coffee beans.

2. Description of Related Art

Coffee roasting machines are known in the art and, conventionally, are large devices for bulk roasting large quantities of beans. As such, conventional coffee roasting machines are incompatible with placement in sales outlets or establishments that sell roasted coffee beans to individual customers, i.e., not bulk sales. Therefore, coffee sales establishments (“retail establishments”), such as grocery stores, generally do not include the capability to roast coffee beans on site for sale to customers. This gives rise to several problems. Coffee beans are freshest within one (1) week of roasting. Most retail establishments, which rely on coffee beans roasted in bulk at off-site roasting facilities, are not able to provide their customers with a consistent inventory of fresh coffee beans. Also, when the retail establishments sell out of one or more types of roasted beans, they are unable to continue sales until a new shipment of those types of roasted beans are received, resulting in reduced sales and profits to the retail establishments, and disappointed customers. Also, some outlets are unwilling to stock certain types of roasted coffee beans or blends because of low sales volumes associated therewith. Accordingly, some customers must go elsewhere to obtain certain types of coffee beans or coffee bean blends.

Moreover, most people do not possess the skills or knowledge necessary to operate a coffee roasting machine.

Therefore, there is a present need in the art for a coffee bean roaster capable of roasting a small or individualized quantity of coffee beans while, at the same time, requiring little or not coffee roasting skills of an operator.

### SUMMARY OF THE INVENTION

The present invention solves these problems, as well as others, by providing a coffee-roasting machine and system and method of use, wherein the coffee-roasting machine has a sufficiently compact size for placement wholly within a retail establishment and capable of roasting reduced or individualized quantities of coffee beans. Additionally, the coffee roasting machine of the present invention is capable of roasting a plurality of different coffee bean types to different degrees of roast, selectable by an operator. Moreover, the coffee roasting machine is operable by a person with little or no coffee roasting skills.

A coffee roasting device according to the present invention includes a bean input hopper for introducing coffee beans therein, a roasting chamber for roasting the introduced coffee beans, a release chute for releasing the coffee beans out of the roasting chamber, an air circulating device for circulating air through the roasting chamber, a heat source for roasting the coffee beans, an emissions control device for removing roast emission products from the circulating air, and a cooling tray for cooling roasted coffee beans released from the roasting chamber. The cooling tray optionally includes a plurality of perforations to facilitate an airflow for convectively cooling the roasted coffee beans provided in the cooling trey. The coffee-roasting device further comprises a chaff collector for collecting chaff or other debris separated from the coffee beans during roasting, a fire suppression device, and a control module for controlling the various operations of the coffee roasting device. The control module includes a processing unit, an input device, and a memory device for storing one or more coffee roasting instruction sets. The processing unit identifies an appropriate coffee roasting instruction set stored in the memory device corresponding to information inputted via the input device, and the processing unit controls roasting according to the coffee roasting instruction set.

It is within the scope of the present invention that the coffee-roasting device conductively or convectively or radiantly roasts the coffee beans. For convective roasting, the heating source heats a volume of air, which is directed to the roasting chamber via internal baffling, for example, to convectively roast the coffee beans. For conductive roasting, the heating source heats a surface to conductively roast the coffee beans. For radiantly roasting, a radiant heat source transmits radiant energy.

According to one embodiment of the present invention, the system includes coffee beans prepackaged in a generally uniform size container. Alternately, the coffee beans are stored in a bulk storage bin. With bulk storage, a predetermined amount of the coffee beans stored in the storage bin are emptied into a package for roasting. According to one embodiment, the predetermined amount of coffee beans is determinable by an indicator provided on the package.

According to a further embodiment, the size of the storage bin and the size of the package are substantially the same. In another embodiment, the batch size of the coffee-roasting device is substantially the same as one or both of the bulk storage bin or the package. Additionally, it is within the scope of the invention that the size of the storage bin, the size of the package, and the batch size of the coffee-roasting apparatus are substantially the same.

The package includes information regarding the coffee beans, such as coffee bean type, a desired level of roast to be applied thereto, and an amount of coffee beans to be roasted. The information is inputtable into the coffee-roasting device via an input device. The information can be transmitted to the coffee roasting device in the form of a code, as user-readable information, or via a transmission device, such as by a transmitter for direct input into the machine. For example, in some embodiments, the input device is a receiver, and the information is transmitted from a transmitter incorporated in or otherwise associated with the package. Moreover, it is within the scope of the invention that the input device is a barcode reader and the information provided on the packages is in the form of a bar code. Further, the information may be in the form of a unique identifier capable of only a single use, so as to prevent refilling and reuse of containers.

The scope of the present invention also includes a method for roasting coffee beans in a coffee-roasting device, the device comprising a bean input hopper for introducing coffee beans, a roasting chamber for roasting the introduced coffee beans, a release chute for releasing the coffee beans out of the roasting chamber, an air-circulating device for circulating air through the roasting chamber, a heat source for roasting the coffee beans, an emissions control device for removing roast emission products from the circulating air, a cooling tray for cooling roasted coffee beans released from the roasting chamber, and a control module for controlling operation of the coffee-roasting device. The control module includes a processing unit, an input device, and a memory device for storing one or more coffee roasting instruction sets. The method of operation includes obtaining an amount of coffee beans; entering coffee bean related information into the input device of the control module; selecting a roast profile instruction set corresponding to the coffee bean type, roast information, and the amount of coffee beans for roasting; inserting the amount of coffee beans into the coffee-roasting device; roasting the amount of coffee beans according to the roast profile instruction set; and transferring the roasted coffee beans to a cooling area for cooling the roasted coffee beans. The coffee bean related information includes, for example, a type of the coffee bean to be roasted, a desired level of roast, and an amount of coffee beans to be roasted.

Obtaining an amount of coffee beans involves, for example, selecting a prepackaged container of coffee beans or emptying a predetermined amount of coffee beans into a package. Entering the coffee bean related information includes, for example, inputting information included with a package of coffee beans into the input device of the coffee-roasting device. The information may be directly read by the input device, manually input by a user via controls of the input device, or received by the input device via a signal transmitted from the package, for example. In one embodiment, the information is a barcode and the input device is a barcode reader, and the information is inputted into the coffee-roasting device by passing the barcode along the barcode reader.

The information can include various types of information regarding the coffee beans, such as coffee bean type, moisture content of the coffee bean, coffee bean roast level, and the amount of coffee beans to be roasted.

It is within the scope of the invention that roasting is accomplished convectively or conductively. Further, cooling of the coffee beans includes cooling the coffee beans conductively via transmitting heat through a surface of the cooling tray, via natural convection, via forced convection by forcing air around or through an amount of roasted coffee beans, or any combination thereof.

Additional advantages and novel features of the invention will be partially set forth in the description that follows, and will also become apparent to those skilled in the art upon examination of the following or upon learning by practice of the invention.

### BRIEF DESCRIPTION OF DRAWINGS

Other aspects of the present invention will be better understood from the following description, along with the accompanying drawings, wherein:

FIG. 1 is a transparent view of an encapsulated coffee-roasting device having an internal cooling tray, according to an embodiment of the present invention;

FIG. 2 is a transparent view of the coffee-roasting device shown in FIG. 1;

FIG. 3 is a cutaway view of a coffee-roasting device having an external cooling tray, according to an alternate embodiment of the present invention;

FIG. 4 is a view of the coffee-roasting device of FIG. 3 illustrating an airflow therethrough;

FIG. 5 is a cutaway view of the coffee-roasting device of FIG. 3 illustrating a path formed by internal baffling;

FIG. 6 is the cutaway view shown in FIG. 5 illustrating an airflow path through the internal baffling;

FIG. 7 is a further cutaway view of the coffee-roasting device shown in FIG. 3 illustrating internal features of a roasting chamber according to an embodiment of the present invention;

FIG. 8 is the cutaway view shown in FIG. 7 illustrating an airflow through an additional portion of the coffee-roasting device;

FIG. 9 shows a coffee-roasting device according to a further embodiment of the present invention;

FIG. 10 illustrates a storage bin and package according to an embodiment of the present invention; and

FIG. 11 is a stand-alone merchandising system according to an embodiment of the present invention.

### DETAILED DESCRIPTION OF THE INVENTION

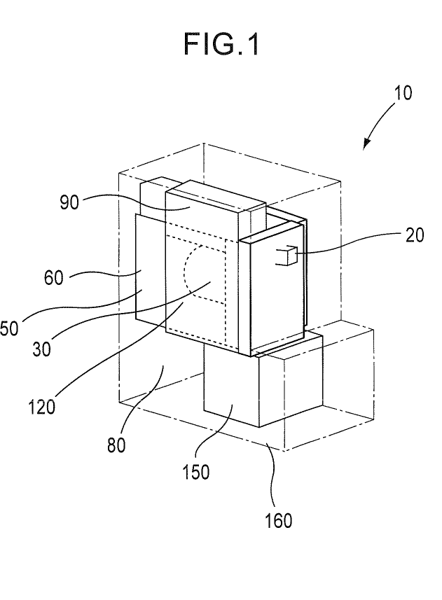

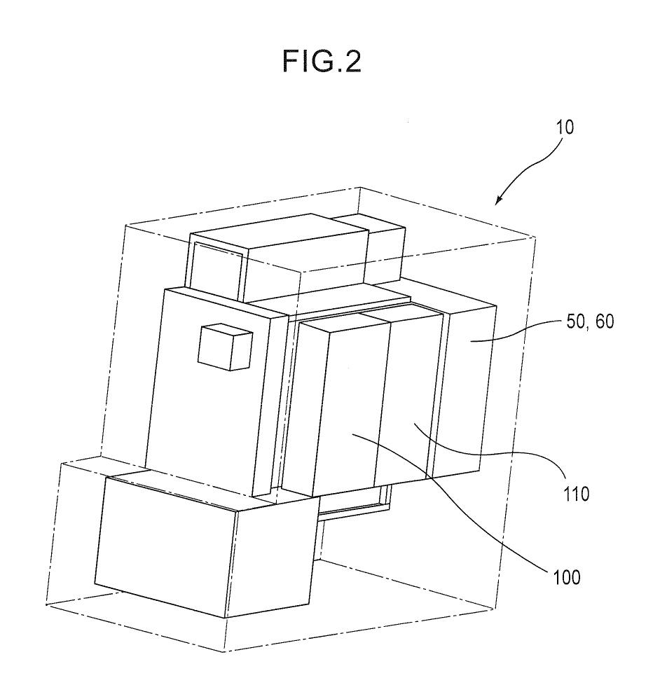

Referring to FIGS. 1 and 2, the present invention relates to a coffee-roasting device and system, and methods of use thereof, including embodiments relating to a complete, self-contained user-friendly operating and merchandising system for roasting a variety of beans using automatic roasting, based on user or automatically inputted bean information.

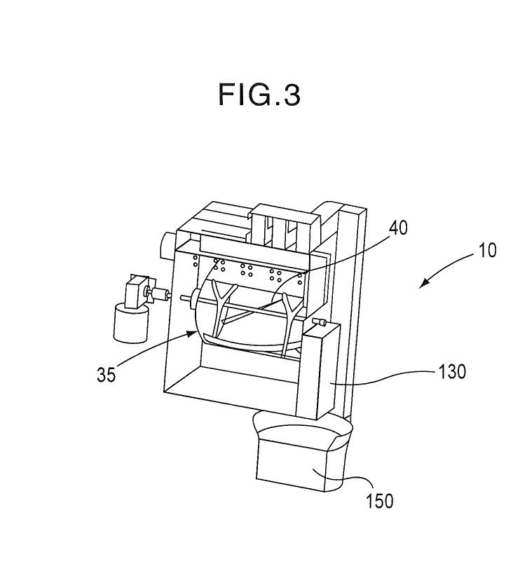

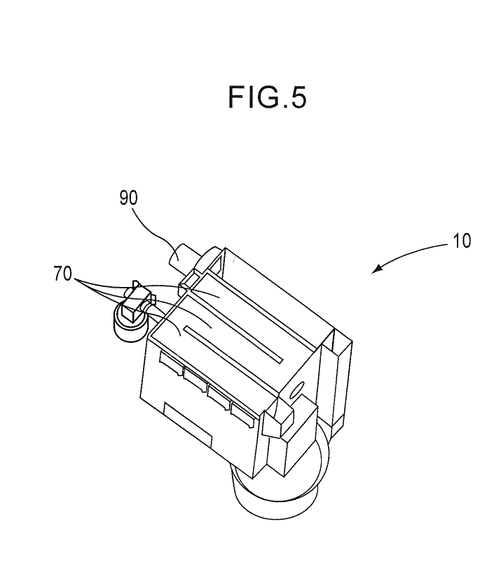

One embodiment of the present invention includes a rotating drum type coffee-roasting device having an internal heat source. As shown in FIG. 1, the coffee roasting device 10 includes a bean input hopper 20 for inputting coffee beans, a rotatable drum with optional internal vanes (drum 35 shown in cutaway view in FIG. 3, the vanes having reference number 40) for agitating coffee beans contained therein, an electric motor 50 for rotating the rotatable drum contained in a roasting chamber 30, a heating unit (not shown in FIG. 1), one or more blowers 60, optional internal baffling 70 (shown in FIG. 5), and a chaff collector 80. Further, the coffee-roasting machine 10 includes an emissions control device 90, a control module 100 (see FIG. 2), a fire suppression system 110 (see FIG. 2), an exhaust system (not shown in FIGS. 1 and 2), and insulation 120 for maintaining a safe external temperature. The coffee-roasting device 10 also includes a bean release chute 130 (not shown in FIGS. 1 and 2) and cooling tray or bin 150.

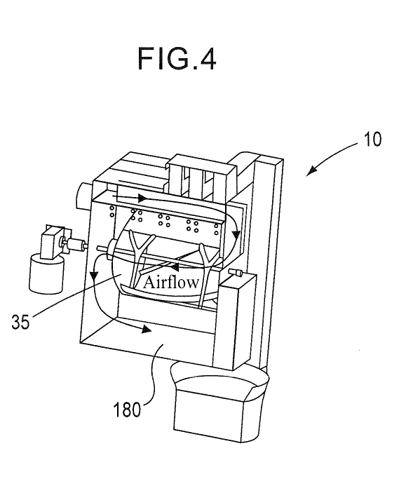

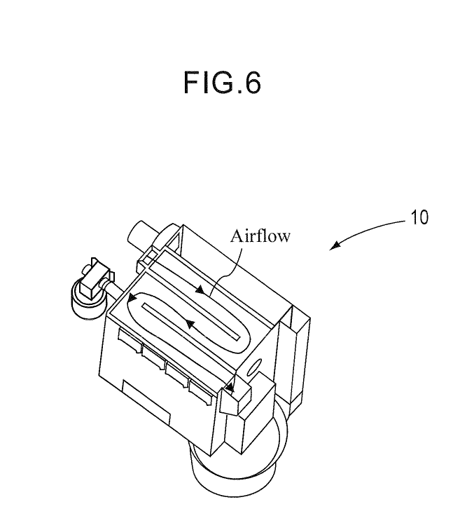

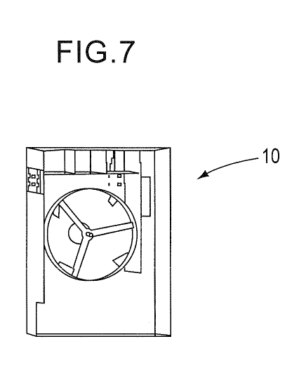

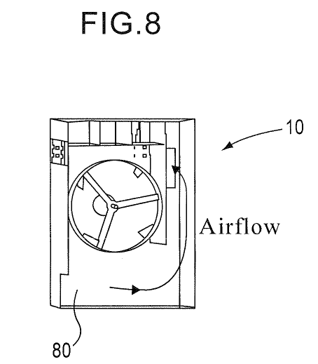

As shown in FIGS. 1 and 2, the cooling tray 150 is enclosed within an enclosure 160 of the coffee roasting device 10. Alternately, as shown in FIGS. 3 through 8, the cooling tray 150 is external to the coffee-roasting device 10. It is within the scope of the present invention, therefore, that the coffee-roasting devices include either an internal or external cooling bin. Further, each component of the coffee-roasting device 10 can be modular, allowing easy manufacture, servicing, and replacement.

The one or more blowers 60 cause external air to enter the coffee-roasting machine 10 and, in a closed-loop system, the one or more blowers 60 also recirculate air within the coffee-roasting device 10. In one embodiment, the coffee-roasting device 10 is an open-loop system with respect to air (i.e., non-recirculating air type) and requires no external ventilation (e.g., due to emissions control, allowing venting within an enclosed space). Alternately, the scope of the invention also includes closed-loop systems (e.g., recirculating air type), which also permit venting to an enclosed space.

The heating unit includes any suitable type of heating source, such as electrical heating elements, gas heating elements, or other types. In one embodiment, the heating element heats incoming and, optionally, recirculated air (such as in closed-loop embodiments). The heated air and/or any recirculated air is subsequently used to roast the coffee beans. Referring to FIGS. 3-8, the heated air is ducted through at least a portion of the coffee-roasting device 10 via the baffling 70. The heated air then moves out of the baffling 70 and into the roasting chamber 30 where the heated air roasts the coffee beans located therein. The heated air is then conducted out of the roasting chamber 30, through the chaff collector 80, through an emission control device 90 (described in more detail below), and then exhausted out of the coffee-roasting machine 10 via the exhaust outlet. Alternatively, all or part of the heated air is recirculated back through the coffee-roasting device 10 to further roast the coffee beans.

However, it is within the scope of the invention that the heating element be disposed within the roasting chamber 30 to apply heat directly to the coffee beans. In such an embodiment the blower 60 circulates incoming air through the roasting chamber, at which point the air is heated, emissions products are collected, and the air is subsequently directed to the emissions control device 90. Optionally, all or a portion of the air is then recirculated to the roasting chamber 30 to further aid in roasting the coffee beans. Accordingly, the scope of one embodiment of the present invention includes both direct-heating and convective heating elements.

While one embodiment of a coffee-roasting device 10 has been described, such embodiment is merely given as an example. Moreover, the present invention is not limited to such an embodiment but includes coffee-roasting machines of different configurations, such as, but not limited to, those including only convection heating, only direct heating, and no recirculation.

The emissions control device 90 can be any suitable device for removing emissions products, such as a catalytic converter or an electrostatic precipitator. The emissions control device 90 removes emission products, such as oils, tars, smoke, residues, etc., from an exhaust emitted by the coffee-roasting device 10. As a result, according to an embodiment of the present invention, the coffee-roasting device 10 is a “vent-less” system, meaning the device 10 does not require the exhaust emitted therefrom to be directed outside of an enclosure, such as an enclosed retail environment, a grocery, or other enclosed space. Further, according to a closed-loop embodiment of the present invention, the emissions control device 90 reduces or eliminates off-flavors imparted to the coffee beans and the likelihood of potential fires occurring as a result of the emission products when all or a portion of the heated air is recirculated.

The control module 100 includes cooperating features (e.g., processor and memory, input device, such as keypad, keyboard, dials, buttons, or switches, and/or bar code scanner, readout (e.g., video screen or liquid crystal display (“LCD”)), speaker (not shown), or other device for providing confirmation and other output information (including, for example, roasting progress and warnings), and electronics and hardware to control and monitor roasting (including, for example, emission level) and to provide output information). Further, the control module 100 controls various operations of the coffee-roasting device 10, such as the internal temperature of various portions of the coffee-roasting device 10, the roasting time, activation of a fire suppression system 110, and the start and stop of the coffee-roasting device 10. Moreover, the control module 100 is used to input information, such as bean type and roasting profiles, to enable the coffee-roasting device 10 to roast a particular type of coffee bean or coffee bean blend to a particular degree of roast, as explained in more detail below. Also described below, the automated or semi-automated aspects of the system permit minimally skilled operators to perform all roasting related functions.

In some embodiments, the processor component allows tracking and statistical and other recordkeeping with regard to the system (e.g., numbers of roasting cycles and most used bean types) and may also include a capability for communicating information (e.g., via a network, such as the Internet) with a centralized location or locations, such as servers.

The coffee-roasting device 10 may also include one or more sensors to indicate failure of particular components and to provide an appropriate indication to inform a user that the coffee-roasting device 10 requires maintenance.

Further, the coffee-roasting device 10 may also include one or more interlocks to prevent operation thereof if one or more requirements are not met. For example, one interlock prevents operation if a chaff catcher is not in place within the chaff collector 80. A second interlock may prevent operation of the system if a water inlet is not connected to the fire prevention system 110 for variations that include this feature. Also, an interlock may prevent operation when one or more components of the coffee-roasting device 10 are not securably attached. A further interlock may prevent operation of the coffee-roasting device 10 where the cooling tray 150 is not in an appropriate position or configuration. It is within the scope of the invention to have other interlocks to prevent operation of the coffee-roasting device 10 when in a particular configuration.

The control module 100 may also include a manual or automatic shut-off for use when, for example, electrical power is lost, the rotatable drum 35 stops rotating, the roasted coffee beans or some other portion of the coffee-roasting device 10 meets or exceeds a predetermined temperature, or for any other reason.

The fire suppression system 110 can be of any type, such as a water or CO₂ based system, and may be made to activate automatically, such as when a temperature of the coffee-roasting device 10 meets or exceeds a predetermined value. In one embodiment, the coffee-roasting device 10 includes one or more temperature sensors located, for example, in the roasting chamber 30, the chaff collector 80, the heating element, and the exhaust system. In some embodiments, the temperature sensors may, for example, be monitored via an LCD or other display. In one embodiment, the fire suppression system 110 includes a water tank (not shown) that must be filled to a predetermined level in order for the coffee-roasting device 10 to operate. Alternatively, the fire suppression system 110 includes an external water connection point (not shown). In a further embodiment, the coffee-roasting device 10 includes a canister of CO₂ that must contain a predetermined pressure in order for the coffee-roasting machine 10 to operate.

When a temperature of the coffee-roasting machine 10 exceeds a predetermined temperature, the fire suppression system 110 is activated, causing automated valves (not shown) to open, thereby releasing the water, CO₂, or other fire suppressant into one or more areas of the coffee-roasting device 10, such as at the locations where the temperature sensors are located. Further, the fire suppression system 110 may also include a manually controlled valve conveniently located for activation by a user.

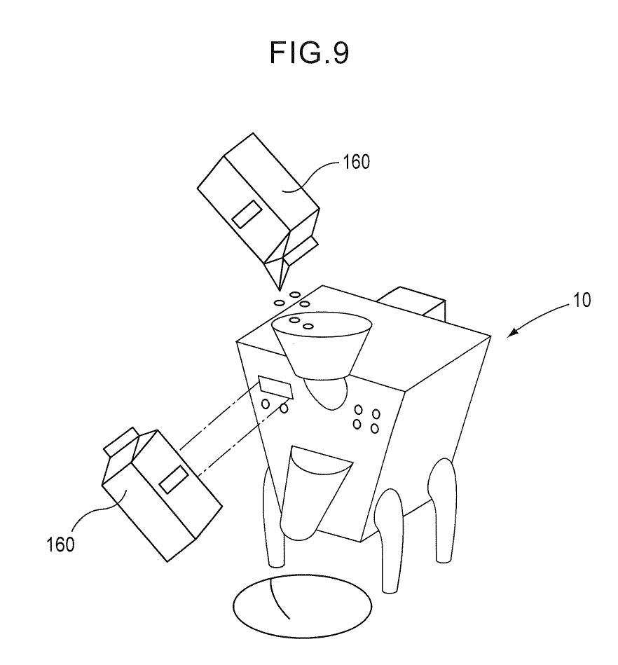

As shown in FIG. 9, the system of one embodiment of the present invention includes packages 170 of unroasted beans of a predetermined size or predetermined sizes. The packages, and information on the packages, are usable alone or in conjunction with user-selected input to program the coffee-roasting device 10 of the system. For example, each package 170 may be of a predetermined volume, size, or weight, such as five pounds of beans in a standard shaped package. For example, the packages 170 may be milk-carton shaped, roughly five by seven inches in cross-section. The use of uniform sized packaging allows easy shipping (e.g., in box containing eight closely packed packages, which may include different bean types) and storage in the integrated bins of a retail unit. The uniform packages in a storage area also allow immediate determination at any time of remaining stocks and the number of packages needed to maximize storage. However, packages of any predetermined size and configuration are within the scope of the invention, and the system of the present invention is not dependent upon any package of any particular shape or size.

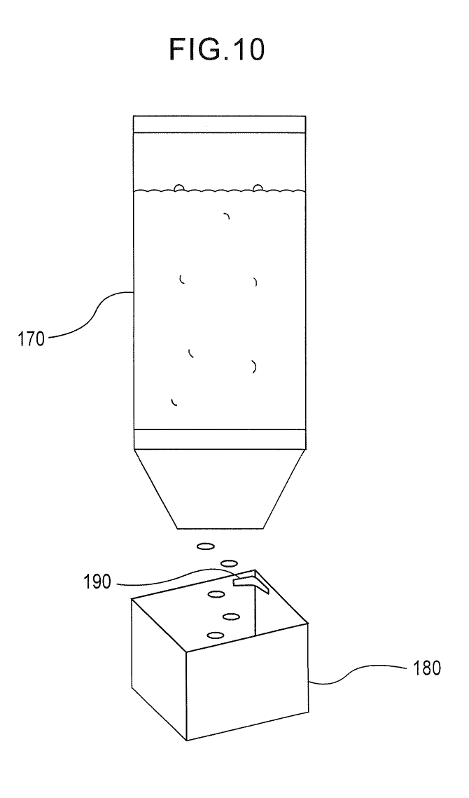

In an alternate embodiment, the unroasted coffee beans are provided in bulk bins 180, as shown in FIG. 10. FIG. 10 illustrates a merchandising system according to the present invention. In one embodiment, each bin 180 is sized to correspond to the batch size of the coffee-roasting device 10, i.e., the capacity of the bin 180 is equal to a full load of coffee beans for roasting by the coffee-roasting device 10. Alternatively, the batch size is substantially equal to the size of a separately provided package 190. Unroasted coffee beans from the bins 180 are emptied into the separately provided package 190 of a predetermined size, for example. A user fills the package 190 with a predetermined amount, such as by filling the package up to a fill line or other indicator 195 on the package 190. Additionally, one or more different packages 190, fillable by the user, may be provided. Each different package 190 may corresponds to a particular coffee bean type, coffee bean blend, or a particular level of roast desired by the user, for example.

Further, the packages 190 include information (interchangeably referred to as “special packaging information”) in the form of a bar code, transponder, or other automatically transmittable information, for example. The information is incorporated with the packaging or usable with the packaging, and operates in conjunction with the control module 100 of the coffee-roasting device 10. For example, the control module 100 may include a barcode reader or receiver capable of receiving the information. The control module 100 reads or receives the information contained with the package 190 for use by the coffee-roasting device 10 of the system. Alternatively, the information included with the packages 190 is user readable information (e.g., manually readable markings, such as weight, bean type, and roast level) and is inputtable into the coffee-roasting device 10 by a user.

The information included with the packages 170 or 190 can include any type of information, such as coffee bean type, coffee bean volume or weight, or the type of roasting to be applied to the coffee beans. For example, the information may include the type of coffee beans or coffee bean blends contained in the package 170 or 190, such as Columbian, Sumatran, Costa Rican, Kenyan, the type or degree of roast (referred to interchangeably as “roast profile”) to be applied to the coffee beans, such as French Roast, Italian Roast, Espresso Roast, or other information relating to the coffee beans or desired roast required by the coffee-roasting device 10 to perform an appropriate roast operation. In an embodiment of the present invention wherein the packages 170 or 190 are configured to hold a predetermined size or weight of coffee beans, the information may only include information regarding coffee bean type or desired roast. Further, the information, according to some embodiments of the present invention, includes a unique identifier that allows the packaging to be useable only once. For example, the information may be in the form of a one-time use code.

According to one embodiment, once the information has been inputted, the coffee-roasting device 10 allows the user to select the type of roast desired. Once all of the necessary information has been inputted, the coffee-roasting device 10 selects the corresponding roast profile instruction set (e.g., instructions for a roasting process performed by the coffee-roasting device to roast a particular type of coffee bean to a particular roast level) and begins the roasting process. In one embodiment of the present invention, the device stores a plurality of roast profile instruction sets, each of which corresponds to a particular type of coffee bean or coffee bean blend and desired roast profile. The roast profile instruction sets are stored in the memory of the control module 100. A roast profile instruction includes the necessary instructions to operate the coffee-roasting device 10 to roast a particular type and amount of coffee bean to a particular roast level. For example, the instructions sets include a required roasting temperature and roasting time for roasting, for example. For a coffee-roasting device 10 according to an embodiment of the present invention that provides a constant roast temperature, the roast profiles may only include information such as roasting time. However, roast profile instruction sets may include other information in addition to roast time and temperature, such as information to start and stop the one or more blowers 60, time to start and stop the heating element, etc. It is within the scope of the invention to include within a roast profile instruction set any and all information necessary to operate the coffee-roasting device 10 to roast a given amount of a particular coffee bean type or coffee bean blend to a desired roast profile.

In an embodiment of the present invention where the roast profile is selectable by the user after the special packaging information (including information such as coffee bean type) has been input into the coffee-roasting device 10, some roast profiles available with one or more coffee bean types may not be available with one or more other coffee bean types, because, for example, some coffee bean types do not produce a good flavor or are otherwise not desirable with a particular roast profile. Moreover, the system of the present invention is usable with any number of different coffee bean types. Further, it is within the scope of the present invention that new roast profile instruction sets may be added or that existing roast profile instruction sets may be deleted or modified to correspond, for example, to changes in available coffee bean types or taste preferences.

In operation, according to an embodiment of the present invention, the coffee-roasting device 10 of the system receives input on a bean type, weight or volume, and desired roast profile. The user of the system selects a bean type (e.g., package of beans) and inputs the type and weight information (e.g., by keypad or automatic input via scanning of a barcode; weight information may always be the same via use of uniform package sizes). The user then inputs or selects a desired roast profile (e.g., dark or “French Roast”). In some embodiments, only certain roast profiles are enabled for some bean types, for example, to protect against improper or inadvertent mis-roasting.

Optionally, a “warming up” indication is provided to the user, if the system needs to warm up before operation, prior to receiving the beans for roasting. The coffee-roasting device 10 determines a proper roasting level for the beans (such as by time and temperature or just time if a single temperature is always used for roasting, adjusted for the particular bean type and roasting characteristics inputted or selected).

The user then dumps or otherwise places the beans from the pre-packaged container into the machine, such as via the input hopper 20. The machine circulates the beans in the drum 30 and roasts the beans, while chaff or other to be discarded portions of the beans are expelled from the drum 30 (e.g., by gravity drop through drum perforations or via use of an opening into a larger volumetric space, producing a pressure drop and subsequent precipitation of chaff). In one embodiment, the blower 60 either continuously operates, or operates intermittently as necessary (e.g., based on sensor information or user selection) so as to siphon smoke or other emissions from the coffee-roasting device 10 of the system, and to direct the emissions to the emission control device 90. The system then proceeds to roast, per the inputted information.

Upon completion of roasting, the roasted beans are either automatically released to the cooling tray 150, or, for example, the system provides an indication to allow the user to manually release the beans to the cooling tray 150. An embodiment having the cooling tray 150 located externally to the coffee-roasting device 10 allows cycling of roasting and cooling. Moreover, this arrangement facilitates three to four roasting cycles per hour using a single machine.

In one embodiment, the cooling tray 150 includes a plurality of perforations therein to provide airflow over the roasted coffee beans for cooling. Additionally, air from the cooling tray 150 can be drawn through a portion of the coffee-roasting device 10 and emissions control device 90 to remove any emission products given off during cooling. Further, the coffee-roasting device 10 may also include a bypass to the emissions control device 90 at a point during cooling when the roasted coffee beans no longer give off any emission products.

Following cooling of the roasted beans, the beans are placed into bins segregated by bean type, which may be used, for example, to fill consumer containers (e.g., coffee bags) for sale at a retail point of purchase. Alternately, the roasted coffee beans may be collected directly by the user into a container upon cooling of the roasted coffee beans. Moreover, the system may include indicator levels (e.g., low level markings) or sensors to indicate when roasting of a type is required or suggested (e.g., to replenish bin level).

Optionally, upon a set number of roastings or other trigger mechanism occurring, the system indicates to the user the need to perform maintenance, such as emptying the chaff collector 80 and cleaning the coffee-roasting device 10. In some embodiments, the coffee-roasting device 10 may be cleaned via exposure to raised temperature from the heating element, while no beans are contained in the drum 30.

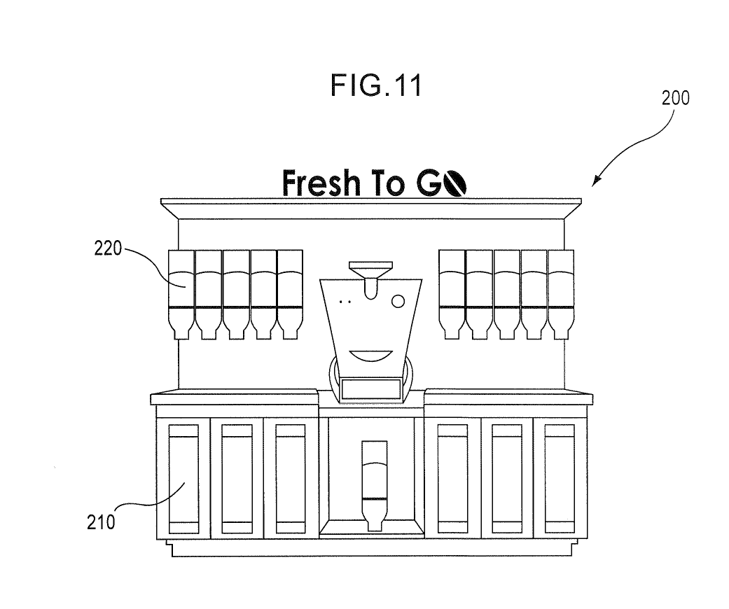

Referring to FIG. 11, one embodiment of the system includes a self-contained retail unit 200 having the encapsulated coffee-roasting device 10, as well as integrated bins 210 or compartments for holding pre-roasted beans and for collecting roasted beans, once roasting is complete. The system optionally includes bins 220 for holding and segregating roasted beans (e.g., for easy packaging), and storage capacity for holding packages of beans prior to roasting, with components of the coffee-roasting device contained behind the fronting unit. Combined with the automated or semi-automated aspects of the system, these units allow minimally skilled operators to perform all roasting related functions. Moreover, the bins 210 and 220 are sized to correspond to a batch size of the coffee-roasting device 10, although bins of any size are within the scope of the present invention.

While there has been described what are at present considered to be preferred embodiments of the present invention, it will be understood that various modifications may be made thereto, and it is intended that the disclosure cover all such modifications as fall within the true spirit and scope of the invention. Other modifications will be apparent to those skilled in the art.

What is claimed is:

1. A coffee roasting apparatus, comprising:
a bean input hopper for receiving coffee beans therein;
a roasting chamber for roasting the introduced coffee beans;
a release chute for releasing the coffee beans out of the roasting chamber;
an air-circulating device for circulating air through the roasting chamber;
a heat source for roasting the coffee beans;
an emissions control device for removing emission products from the circulating air;
a cooling tray for cooling roasted coffee beans released from the roasting chamber; and
a control module for controlling operation of the apparatus, the control module including:
a processing unit;
an input device; and
a memory for storing one or more coffee roasting instruction sets;
wherein the processing unit identifies an appropriate coffee roasting instruction set stored in the memory device corresponding to information inputted via the input device, and wherein the processing unit controls roasting time according to the coffee roasting instruction set.

2. The apparatus according to claim 1, wherein the cooling tray includes a plurality of perforations to facilitate an airflow for convectively cooling roasted coffee beans provided in the cooling tray.

3. The apparatus according to claim 2, wherein the air-circulating device induces the airflow.

4. The apparatus according to claim 2, wherein the airflow is directed through the emissions control device for removing emission products released during cooling of the coffee beans.

5. The apparatus according to claim 1, further comprising:
an enclosure, wherein the cooling trey is provided within the enclosure.

6. The apparatus according to claim 1, wherein the heat source heats a surface of the roasting chamber so as to conductively roast the coffee beans.

7. The apparatus according to claim 1, wherein the heat source heats a volume of the circulating air to convectively roast the coffee beans.

8. The apparatus according to claim 1, wherein the roasting chamber includes a rotatable drum.

9. The apparatus according to claim 8, further comprising:
a motor for rotating the rotatable drum.

10. The apparatus according to claim 1, further comprising a debris collector for collecting chaff and other debris released from the coffee beans during roasting.

11. The apparatus according to claim 1 further comprising a fire suppression system.

12. The apparatus according to claim 11, wherein the fire suppression system is automatically activated upon the occurrence of a predetermined event.

13. The apparatus according to claim 12, wherein the predetermined event is a predetermined temperature of a portion of the apparatus.

14. The apparatus according to claim 11, wherein the fire suppression system is a water-based system.

15. The apparatus according to claim 14, wherein the water-based system is a self-contained system.

16. The apparatus according to claim 11, wherein the fire suppression system is CO₂ based.

17. The apparatus according to claim 1, wherein the emissions control device is a catalytic converter.

18. The apparatus according to claim 1, wherein the emissions control device is an electrostatic precipitator.

19. The apparatus according to claim 1, further comprising:
at least one interlock, wherein operation of the apparatus is prevented when the at least one interlock is in a predetermined condition.

20. The apparatus according to claim 1, wherein the control module further comprises a display device for displaying information to a user.

21. The apparatus according to claim 20, wherein the display device displays progress of a coffee roasting cycle.

22. The apparatus according to claim 20, wherein the display device displays operational information.

23. The apparatus according to claim 22, wherein the operational information includes alarm and maintenance information.

24. The apparatus according to claim 1, further comprising:
a debris collector for collecting debris released from the coffee beans during roasting.

25. The apparatus according to claim 1, wherein the input device includes a barcode reader, and wherein the information includes a barcode.

26. The apparatus according to claim 1, wherein the input device is a receiver for receiving the information via a transmission.

27. The apparatus according to claim 1, wherein the input device includes a manual control, and wherein the information is manually inputted into the control module via the manual control.

28. The apparatus according to claim 1, wherein the information is a unique identifier capable of only a single use.

29. A system for roasting coffee comprising:
a coffee-roasting apparatus, including:
a bean input hopper for introducing coffee beans into the apparatus;
a roasting chamber for roasting the introduced coffee beans;
a release chute for releasing the coffee beans out of the roasting chamber;
an air-circulating device for circulating air through the roasting chamber;
a heat source for roasting the coffee beans;
an emissions control device for removing roast emission products from the circulating air;
a cooling tray for cooling roasted coffee beans released from the roasting chamber; and
a control module for controlling operation, the control module including:
a processing unit;
an input device, and
a memory device for storing one or more coffee roasting instruction sets, and
a package for an amount of coffee beans, the package including information related to the amount of coffee beans;
wherein the information is inputtable into the input device of the control module and is processed by the processing unit, wherein the processing unit identifies an appropriate coffee roasting instruction set stored in the memory device corresponding to the information, and wherein the processing unit controls roasting according to the coffee roasting instruction set.

30. The system according to claim 29, wherein the coffee beans are prepackaged in a package of a predetermined size.

31. The system according to claim 30, wherein the predetermined package size is substantially equal to a batch roasting size of the coffee-roasting device.

32. The system according to claim 29, further comprising:
a bulk storage bin for storing unroasted coffee beans, wherein a predetermined amount of the unroasted coffee beans in the storage bin is transferred to the package.

33. The system according to claim 32, wherein the predetermined amount of is selected using an indicator provided on the package.

34. The system according to claim 29, wherein the information included with the package identifies a type of coffee bean contained therein.

35. The system according to claim 29, wherein the information included with the package identifies a level of roast to be applied to the coffee beans contained therein.

36. The system according to claim 29, wherein the information included with the package identifies an amount of the coffee beans contained therein.

37. The system according to claim 29, wherein the input device is a receiver, and wherein the information included with the package is inputted into the receiver via a transmitted signal.

38. The system according to claim 29, wherein the input device is a barcode reader and wherein the information provided on the packages includes bar code information.

39. The system according to claim 29, wherein the information includes a unique identifier rendering the package capable of only a single use.

40. A method for roasting coffee beans in a coffee roasting apparatus comprising:
introducing coffee beans to a bean input hopper;
roasting the introduced coffee beans for a predetermined time;
circulating air through the roasting chamber;
roasting the coffee beans;
removing roast emission products from the circulating air;
releasing the coffee beans out of the roasting chamber;
cooling the roasted coffee beans released from the roasting chamber; and
controlling coffee-roasting operation.

41. The method of claim 40, further comprising:
obtaining an amount of coffee beans;
receiving coffee bean related information; and
receiving selection of a roast profile instruction set corresponding to the coffee bean and roast information.
